(19) United States
(12) Patent Application Publication
(10) Pub. No.: US 2008/0042565 A1
(43) Pub. Date: Feb. 21, 2008

(54) Structure of Plasma Display Panel

(75) Inventor: Lu-Yi Yang, Padeh City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Chunghwa Picture Tubes, Ltd., Padeh City (TW)

(21) Appl. No.: 11/465,685

(22) Filed: Aug. 18, 2006

(51) Int. Cl. H01J 17/49

(52) U.S. Cl. 313/582; 313/587

(57) ABSTRACT

A structure of plasma display panel includes a first panel and a second panel wherein the auxiliary electrode of the first panel is formed of multiple conductors that are arranged in pair on each pair of transparent electrodes and electrically connected with the transparent electrodes. In addition., the spacing of blue subpixel area corresponding to the auxiliary electrode is larger than that of the red or green subpixel area corresponding to the auxiliary electrode. Via enlarging the spacing of blue subpixel area corresponding to the auxiliary electrode, the aperture ratio and the light-emitting area of blue subpixel is increased, and thus, the object of raising the color temperature of the plasma display panel is achieved.

### BACKGROUND OF THE INVENTION

1. Field of the Invention

The present invention relates to a structure of plasma display panel, particularly to one, wherein the spacing of the blue sub-pixel area of a first substrate corresponding to the auxiliary electrode is enlarged.

2. Description of the Related Art

The color temperature is a measure scale of light color and the measurement unit of color temperature is ° K. (Kelvin). The color temperature of television (light-emitting body) or photography (light-reflecting body) can be modified artificially, for example, in photography, an incandescent lamp (3200° K.) can be used to control the color temperature, or a filter for red light can be installed to the camera lens to screen red light so that the photograph will have a higher color temperature. The color with higher color temperature, which is called color of cold tone, will be biased to blue or violet, and the color with lower color temperature, which is called color of warm tone, will be biased to yellow or red.

Currently, the standard color temperature of the plasma display panel is 7400° K.; however, if not specially treated, the color temperature of the plasma display panel tends to be lower than the standard color temperature and is about from 5000 to 6000° K. Among the red, green, and blue constituent colors of the plasma display panel the sequence of their contributions of raising color temperature is: B>R>G; therefore, with respect to solving low color temperature in plasma display panel, the improvement relating to blue subpixel has the best efficiency of raising color temperature.

FIG. 1 shows schematically the structure of the conventional plasma display panel that is improved via adjusting the area of transparent electrode to obtain a better white color temperature and is a U.S. Publication Pat. No. 6,713,960. It disclosed the width of a transparent electrode 2b will be varied according to its color on a scanning electrode 2. Hence, the widths (WR0, WG1, WB1) of transparent electrodes (2bR, 2bG, 2bB) may have a relationship of WB1>WR0>WG1 in Y axle. Similarly, on a supporting electrode 3, the width of the transparent electrode 3b is also varied according to its color. Therefore, the widths (WR0, WG1, WB1) of transparent electrodes (3bR, 3bG, 3bB) may have a relationship of WB1>WR0>WG1 in Y axle. With the variation of the widths, the plasma display panel can obtain an adequate value by adjusting the white color temperature without a controlling of input gain which will degrade color tone.

### SUMMARY OF THE INVENTION

It is an object of the present invention to increase the light-emitting area of blue subpixel in order to raise the color temperature of the plasma display panel via adjusting the spacing of the blue subpixel area of a first substrate corresponding to between the auxiliary electrodes so as to raise the color temperature of the plasma display panel.

To achieve the aforementioned object, the present invention provides a structure of plasma display panel, which comprises a first panel and a second panel

The first panel includes a first substrate; at least a transparent electrode, which is arranged in pair on the first substrate and disposed in the positions corresponding to each red, green, and blue subpixel area of the second panel respectively; a plurality of auxiliary electrodes, which are formed of multiple strips of conductors that are arranged in pair on the transparent electrode and electrically connected with the transparent electrodes. And each spacing of the blue subpixel area corresponding to the auxiliary electrode is larger than that of the red subpixel area corresponding to the auxiliary electrode or that of the green subpixel area corresponding to the auxiliary electrode; a black stripe layer, which is formed on the first panel and disposed in the positions corresponding to the areas outside of the subpixel areas of the second panel; a transparent dielectric layer, which overlays the transparent electrodes and the black stripe layer; a protection layer, which overlays the transparent dielectric layer.

The second panel at least includes a second substrate; a rib, which is formed on the second substrate as a spacer for the first panel and second panel, to separate and prevent the three kinds of fluorescence to be mixed; a color phosphor layer, which is using the different colors of fluorescence coated on the inner of the different ribs to form red, green, and blue subpixel areas; and an address electrode, which is deposed on the areas formed by each rib.

### BRIEF DESCRIPTION OF THE DRAWINGS

To enable the objectives, the characteristics of the structure and the functions of the present invention to be further understood, the preferred embodiments of the present invention is to be described in detail below in cooperation with the attached drawings, and wherein:

FIG. 1 shows schematically the structure of the conventional plasma display panel that had been improved via adjusting the transparent electrode;

FIG. 2 shows schematically a sectional view of a unitary pixel in accordance with an embodiment of the present invention;

FIG. 3 shows schematically the strip-like structure of plasma display panel in accordance with an embodiment of the present invention wherein the arrangement method of the conductors is an X—Y—X—Y one,

FIG. 4 shows schematically the grid-like structure of plasma display panel in accordance with an embodiment of the present invention wherein the arrangement method of the conductors is an X—Y—Y—X one; and

FIG. 5 shows schematically the honeycomb-like structure of plasma display panel in accordance with an embodiment of the present invention wherein the arrangement method of the conductors is an X—Y—Y—X one.

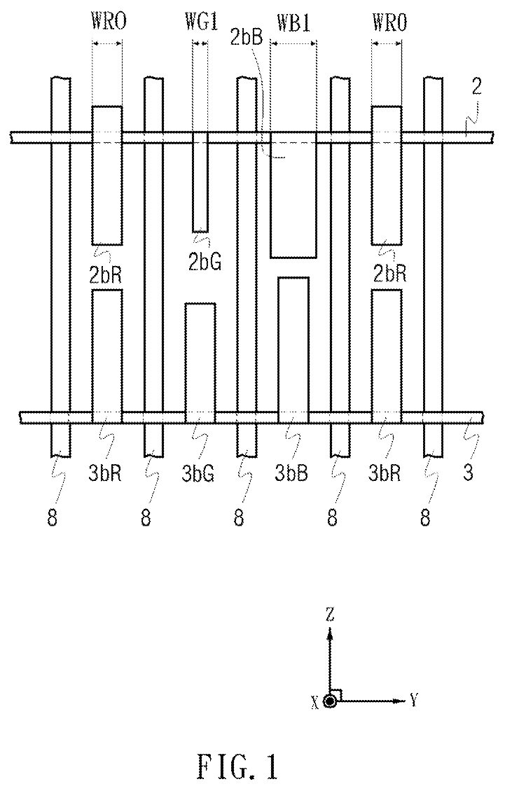

### DETAILED DESCRIPTION OF THE INVENTION

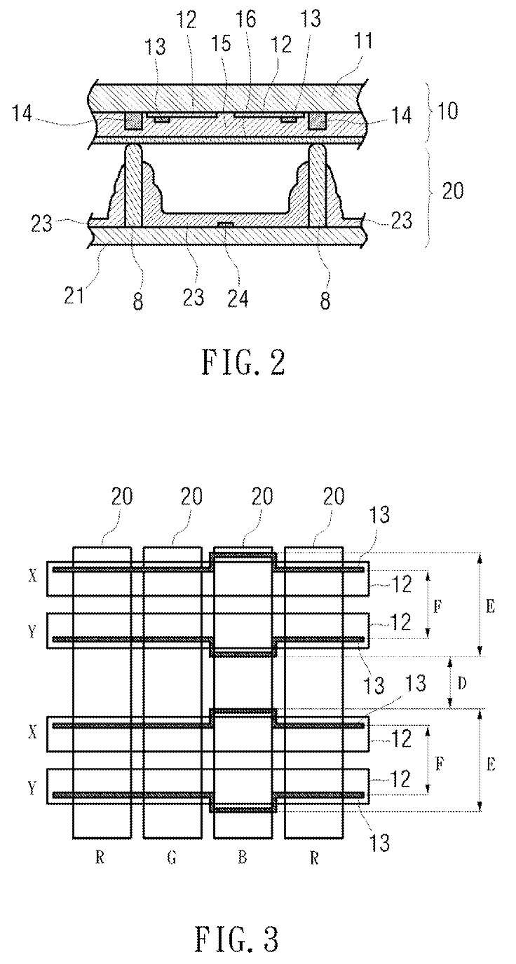

FIG. 2 shows schematically a sectional view of a unitary pixel in accordance with an embodiment of the present invention The present invention is a structure of plasma display panel, which comprises: a first panel 10 and a second panel 20. In the second panel 20, several blue, red, and green subpixel areas are formed. The areas of blue, red, and green subpixel are identical. Besides, in the first panel 10, the spacing E of the blue subpixel area corresponding to the auxiliary electrode is larger than that F of the red subpixel area corresponding to the auxiliary electrode or that F of the green subpixel area corresponding to the auxiliary electrode.

The first panel 10 includes a first substrate 11; several transparent electrodes, which are arranged in pair on the first panel 10; several auxiliary electrodes 13, which are also arranged in pair on those pairs of transparent electrodes 12 and electrically connected with the transparent electrodes 12, wherein the spacing E of the blue subpixel area corresponding to the auxiliary electrode 13 is larger than that F of the red subpixel area corresponding to the auxiliary electrode 13 or that F of the green subpixel area corresponding to the auxiliary electrode 13; a black stripe layer 14, which is formed on the first panel 10; a transparent dielectric layer 15, which overlays the transparent electrodes 12 and the black stripe layer 14; a protection layer 16, which overlays the transparent dielectric layer 15.

The first substrate 11 can be a transparent glass or a transparent plastic board. When the conductors of the auxiliary electrode 13 supply the power, with the expansion of its area, the transparent electrode 12 creates an electrical field, which excites the gas to obtain a plasma effect and emit an ultraviolet ray. The transparent electrode 12 is made of an indium-Tin-Oxide electrically-conductive film (ITO film) or a Tin Dioxide (SnO2) electrode.

For the auxiliary electrode 13, in order to maintain a stable voltage for gas discharge, the auxiliary electrode 13 is specially formed on the transparent electrode 12 to increase the electrical conductivity. The auxiliary electrode 13 is made of a material with superior electrical conductivity, which can be a Chromium/Copper/Chromium (Cr/Cu/Cr) composite material or a Silver (Ag) material. When the Chromium/Copper/Chromium (Cr/Cu/Cr) composite material is adopted, those three metallic materials are sequentially coated on the panel having the transparent electrode 12 via a Film Process, and then those metallic materials are sequentially etched via a Wet-Etching process to form the desired pattern.

The black stripe layer 14, or named black contrast layer otherwise, is used to improve the contrast of the image on the plasma display panel and is formed beside the auxiliary electrode 13 of the first panel 10. The fabrication method thereof can be a direct-printing method wherein a black paste is directly printed into the desired pattern, or a method of printing a photosensitive paste with a succeeding etching to form the desired pattern.

The transparent dielectric layer 15, which is made of a transparent dielectric glass, is formed on the transparent electrodes 12 and the black stripe layer 14 via a Planographic Printing Method or a Dry-Film Method. The requirements of the transparent dielectric layer 15 are: 85% of general transparency, minimum 2 mm of flatness, no gas bulb, higher voltage resistance, etc.

The protection layer 16 is made of a Magnesium Oxide (MgO).

The second panel 20 at least includes a second substrate 21; at least a rib 8 formed on the second substrate 21 so as to be a spacer between the first panel 10 and the second panel 20 for providing a discharging space between the first panel 10 and the second panel 20 and also preventing the three kinds of fluorescence to be mixed.

A color phosphor layer 23, which is using the different colors of fluorescence coated on the inner of the different ribs 8 to form red (R), green (G), and blue (B) subpixel areas. It is no allowed that there is a color mixing problem for any adjacent two colors. The color phosphor layer 23 can emit color lights having different wavelengths by absorbing ultraviolet (UV) rays.

An address electrode 24 is disposed on the areas formed by each rib 8. The plasma display can be divided into two types—the direct current (DC) type and alternating current (AC) type. Currently, the development of the plasma display is focused on the AC type. The main function of the address electrode 24 of the AC typed plasma display is for write-in data, so it is also called “data electrode”. The address electrode 24 is a linear type and its position must coordinate that of the transparent electrodes 12 of the first panel 10 and the auxiliary electrode 13; otherwise, data would not be able to write-in.

FIG. 3 shows schematically the strip-like structure of plasma display panel in accordance with an embodiment of the present invention wherein the arrangement method of the conductors is an X—Y—X—Y one. The X—Y—X—Y is according to the arrangement method of the auxiliary electrode 13 of the first panel 10 of the plasma display panel, wherein X represent a first polarity, i.e. the auxiliary electrode 13 corresponding to X is a first-polarity one, and wherein Y represent a second polarity, i.e. the auxiliary electrode 13 corresponding to Y is a second-polarity one. When two neighboring auxiliary electrodes 13 are of different polarity, an appropriate distance should be kept between those two neighboring auxiliary electrodes as a potential difference existing therebetween. In the X—Y—X—Y arrangement of the present invention, the auxiliary electrodes 13 position at both sides of the non-subpixel area, the minimum spacing D of the non-subpixel area is equal to or larger than 300 μm, and the spacing E on the blue subpixel area of each pair of the auxiliary electrodes 13 corresponding to the auxiliary electrode 13 ranges from 320 to 350 μm, and the spacing F on the red subpixel area of each pair of the auxiliary electrodes 13 corresponding to the auxiliary electrode 13 or the green subpixel area of the auxiliary electrodes 13 corresponding to the auxiliary electrode 13 is 300 μm.

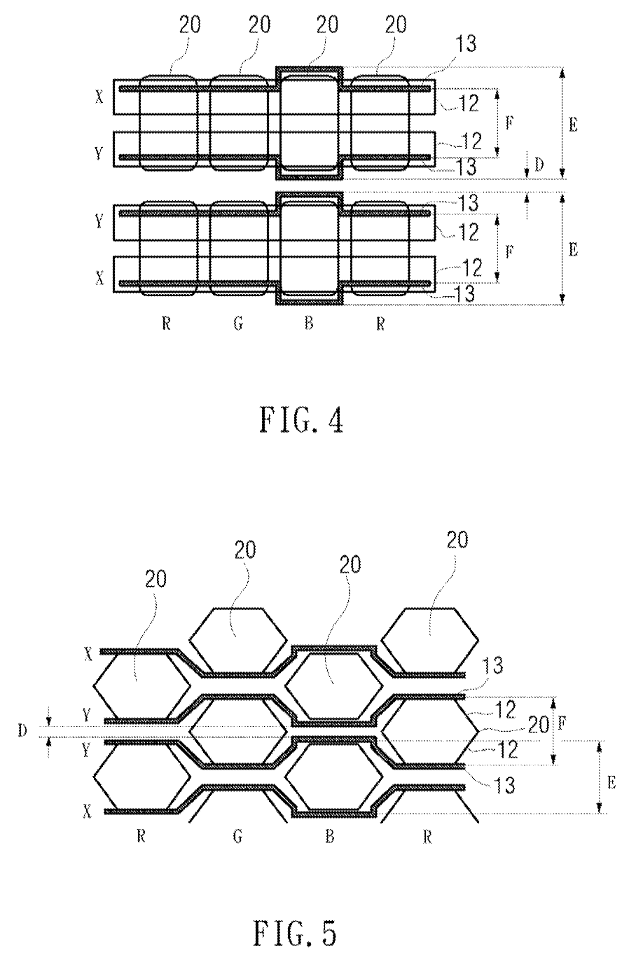

FIG. 4 shows schematically the grid-like structure of plasma display panel in accordance with an embodiment of the present invention wherein the arrangement method of the conductors is an X—Y—Y—X one. The X—Y—X—Y is according to the arrangement method of the auxiliary electrode 13 of the first panel 10 of the plasma display panel, wherein X represent a first polarity, i.e. the auxiliary electrode 13 corresponding to X is a first-polarity one, and wherein Y represent a second polarity, i.e. the auxiliary electrode 13 corresponding to Y is a second-polarity one. When two neighboring auxiliary electrodes 13 are of the same polarity, the spacing therebetween can be shortened obviously as those two auxiliary electrodes 13 are at the same electrical potential. In the X—Y—Y—X arrangement of the present invention, the auxiliary electrodes 13 position at both sides of the non-subpixel area, the minimum spacing D of the non-subpixel area is equal to or larger than 60 μm, and the spacing E on the blue subpixel area of each pair of the auxiliary electrodes 13 corresponding to the auxiliary electrode 13 ranges from 320 to 350 μm, and the spacing F on the red subpixel of each pair of the auxiliary electrodes 13 corresponding to the auxiliary electrode 13 or the green subpixel area of the auxiliary electrodes 13 corresponding to the auxiliary electrode 13 is 300 μm.

FIG. 5 shows schematically the honeycomb-like structure of plasma display panel in accordance with an embodiment of the present invention wherein the arrangement method of the conductors is an X—Y—Y—X one. Each pair of the auxiliary electrodes 13 on both sides of each subpixel area has the shape of honeycomb or parallel strips. In addition, for the auxiliary electrodes 13 position at both sides of the non-subpixel area, the minimum spacing D of the non-subpixel area is equal to or larger than 60 μm, and the spacing E on the blue subpixel area of each pair of the auxiliary electrodes 13 corresponding to the auxiliary electrode 13 ranges from 320 to 350 μm, and the spacing F on the red subpixel of each pair of the auxiliary electrodes 13 corresponding to the auxiliary electrode 13 or the green subpixel area of the the auxiliary electrodes 13 corresponding to the auxiliary electrode 13 is 300 μm.

By increasing the spacing of the blue subpixel area corresponding to the auxiliary electrode 13, the aperture ratio of the blue subpixel area B can be increased so as to increase the size of emitting area of the blue subpixel area B. The blue color is a color having high color temperature, so it has more obviously effect for blue color to raising color temperature than that of the red and green colors. The present invention can also adjust the sizes of each subpixel's area without using ribs or without adjusting the sizes of the transparent electrodes 12.

The present invention can accomplish at least the following efficacies:
1. The present invention can accomplish the efficacy of raising the color temperature of the plasma display panel with no need of modulating the area of each subpixel by modifying the rib.
2. The present invention can accomplish the efficacy of raising the color temperature of the plasma display panel with no need of adjusting the size of the transparent electrode.

Those described above are only the preferred embodiments of the present invention. Any modification and variation according to the claims of the present invention should not depart from the spirit and the scope of the present invention and is also to be regarded as the embodiment of the present invention.

What is claimed is:

1. A structure of plasma display panel, comprising:
a first panel including:
a first substrate;
a transparent electrode layer, which is arranged in pair on said first substrate and disposed in the positions corresponding to red, green, and blue subpixel areas of a second panel respectively;
a plurality of auxiliary electrodes, which includes multiple strips of conductors that are arranged in pair on pairs of said transparent electrodes and electrically connected with said transparent electrodes wherein the spacing of blue subpixel area on said pairs of conductors corresponding to said auxiliary electrode is larger than that of red subpixel area corresponding to said auxiliary electrode or that of green subpixel area corresponding to said auxiliary electrode;
a transparent dielectric layer, which overlays said transparent electrodes; and
a protection layer, which overlays said transparent dielectric layer; and
a second panel, comprising:
a second substrate;
at least a rib formed on said second substrate so as to be a spacer between said first panel and said second panel for preventing the three kinds of fluorescence to be mixed;
a color phosphor layer, which is using the different colors of fluorescence coated on the inner of said different ribs to form red, green, and blue subpixel areas; and
an address electrode disposed on the areas formed by said each rib.

2. The structure of plasma display panel as claimed in claim 1, wherein said first substrate includes a transparent glass or a transparent plastic board.

3. The structure of plasma display panel as claimed in claim 1, wherein said transparent electrode includes an Indium-Tin-Oxide (ITO) film or a Tin Dioxide (SnO2) electrode.

4. The structure of plasma display panel as claimed in claim 1, wherein the material of said conductor is selected from the group of Chromium, Copper, and Chromium (Cr/Cu/Cr) composite material and Silver (Ag) material.

5. The structure of plasma display panel as claimed in claim 1, wherein the material of said transparent dielectric layer includes a transparent dielectric glass.

6. The structure of plasma display panel as claimed in claim 1, wherein the material of said protection layer includes a Magnesium Oxide (MgO).

7. The structure of plasma display panel as claimed in claim 1, wherein the arrangement method of said conductors of said conductive layer is an X—Y—Y—X one, and each pair of said conductors positioned at both sides of each said subpixel area has a shape of honeycomb or parallel strips.

8. The structure of plasma display panel as claimed in claim 7, wherein the minimum spacing between said conductors positioned at both sides of said non-subpixel area is larger than or equal to 60 μm.

9. The structure of plasma display panel as claimed in claim 8, wherein said spacing of blue subpixel area corresponding to said auxiliary electrode ranges from 320 to 350 μm.

10. The structure of plasma display panel as claimed in claim 8, wherein said spacing of red subpixel area corresponding to said auxiliary electrode or green subpixel area corresponding to said auxiliary electrode is 300 μm

11. The structure of plasma display panel as claimed in claim 1, wherein the arrangement method of said conductors is an X—Y—X—Y one and each pair of said conductors positioned at both sides of each said subpixel area has a shape of parallel strips.

12. The structure of plasma display panel as claimed in claim 11, wherein the minimum spacing between said conductors positioned at both sides of said non-light-emitting zone is larger than or equal to 300 μm.

13. The structure of plasma display panel as claimed in claim 12, wherein said spacing of blue subpixel area corresponding to said auxiliary electrode ranges from 320 to 350 μm.

14. The structure of plasma display panel as claimed in claim 12, wherein said spacing of red subpixel area corresponding to said auxiliary electrode or green subpixel area corresponding to said auxiliary electrode is 300 μm.
